(19) United States
(12) Patent Application Publication
(10) Pub. No.: US 2026/0056424 A1
(43) Pub. Date: Feb. 26, 2026

(54) LOUPE SUPPORTING EYEWEAR SYSTEM

(71) Applicant: Berry's Manufacturing of Utah, Inc., St. George, UT (US)

(72) Inventors: Tony Berry, Santa Clara, UT (US); Tyler Berry, St. George, UT (US)

(73) Assignee: Berry's Manufacturing of Utah, Inc., St. George, UT (US)

(21) Appl. No.: 19/309,386

(22) Filed: Aug. 25, 2025

Related U.S. Application Data
(60) Provisional application No. 63/686,415, filed on Aug. 23, 2024.

(51) Int. Cl. G02C 9/04; G02B 25/00; G02C 7/08

(52) U.S. Cl. CPC G02C 9/04; G02B 25/002; G02C 7/086; G02C 7/088; G02C 2200/08; G02C 2200/20

(57) ABSTRACT

A loupe supporting eyewear system has loupe supporting shelves removably couplable to eyewear frames that are configured to hold loupes and monocles of varying dimensions and sizes. The loupe supporting eyewear system may be configured to hold the loupe in front of either the left or right eye, or both. The interchangeable loupe supporting shelves accommodate loupes for use across multiple industries, including gemology, dentistry, watchmaking, coin collecting, and others. The loupe supporting eyewear system is cross-compatible with a user's preexisting loupes.

### CROSS-REFERENCE TO RELATED APPLICATIONS

This application claims the benefit of U.S. Provisional Application Ser. No. 63/686,415, filed on Aug. 23, 2024, which is incorporated herein by reference.

### TECHNICAL FIELD

The present disclosure relates to eyewear for supporting loupes and monocles.

### BACKGROUND

Optical loupes have a long history, with their first applications dating back to the 1870s in the field of surgical operations. Initially, simple optical loupes provided basic magnification, but over time, advancements in lens technology, including compound and prismatic lenses, significantly improved image quality. As the image quality improved, the use of loupes expanded into a variety of fields such as gemology, watchmaking, dentistry, coin collecting, and others.

Despite advancements in lens technology and diversification in the use of loupes, traditional methods of using these devices have remained largely unchanged. Many users, both in past centuries and continuing through the present, typically hold the loupe in front of their eye or clench it with their eye socket to free their hands. These methods of use present significant drawbacks. For example, holding the loupe manually can be uncomfortable and fatiguing over extended periods, while clenching the loupe with the eye socket may also result in fatigue and often results in the loupe falling to the floor, leading to potential damage or scratching.

Modern attempts to address these issues have led to the development of headwear and eyewear devices designed to support magnifying objects. However, these solutions often come with their own set of problems. Many of these devices are expensive and may not be compatible with a user's existing equipment. Given that loupes vary in dimensions and shape according to the level of magnification and the specific field of use, users often face difficulties in finding a suitable supporting system that can accommodate their personal loupes, or headwear that can be interchangeable for different levels of magnification.

Furthermore, the need for versatility in loupe positioning is another critical concern. Users may require the ability to position the loupe in front of either the left or right eye, or both, depending on the specific circumstances and tasks at hand. Current solutions do not adequately address this need, leading to inefficiencies and frustration among users.

Therefore, there is a clear need for a loupe supporting eyewear system that provides for interchangeable with each eye, and which is cross-compatible with a multiple loupes and monocles across fields of use. Such a system should also offer the flexibility to position the loupe in front of either eye, or both eyes, providing a more efficient and user-friendly experience. The present invention solves these and other problems.

### SUMMARY OF EXAMPLE EMBODIMENTS

In some embodiments, a loupe supporting eyewear system comprises eyewear frames and one or more loupe holding shelves. The eyewear frames comprise a first temple arm comprising a first hinge, a second temple arm comprising a second hinge, a first rim, a second rim, and a bridge. The one or more loupe holding shelves further comprise a first semicircular ridge, a second semicircular ridge, a body, and a lip. It will be appreciated that the one or more loupe holding shelves are interchangeable between the first and second rim and may come in a variety of sizes to accommodate loupes of corresponding dimensions.

In some embodiments, a loupe supporting eyewear system has a first configuration in which the loupe holding shelf is coupled to the first rim. A loupe supporting eyewear system has a second configuration in which the loupe holding shelf is coupled to the second rim. A loupe supporting eyewear system has a third configuration in which a first loupe holding shelf is coupled to the first rim and a second loupe holding shelf is coupled to the second rim. It will be appreciated that the first configuration and the second configuration may be used depending on the dominant eye of the user, or based upon user preference. The third configuration may be used in circumstances where the user intends to utilize loupes for both eyes, as often occurs during prolonged periods of use when the user does not want differential fatigue between the eyes.

### BRIEF DESCRIPTION OF THE DRAWINGS

FIG. 1 illustrates a front, right, side perspective view of a loupe supporting eyewear system;

FIG. 2 illustrates a rear, top perspective view of a loupe supporting eyewear system;

FIG. 3 illustrates an exploded view of a loupe supporting eyewear system;

FIG. 4 illustrates a rear, right perspective view of a loupe supporting eyewear system with a temple arm removed;

FIG. 5 illustrates a rear elevation view of the frames with the temple arms removed of a loupe supporting eyewear system;

FIG. 6 illustrates a rear, top perspective view of a loupe holding shelf of a loupe supporting eyewear system;

FIG. 7 illustrates a rear, side perspective view of a loupe holding shelf of a loupe supporting eyewear system;

FIG. 8 illustrates a front, bottom perspective view of a loupe holding shelf of a loupe supporting eyewear system;

FIG. 9 illustrates a top plan view of a loupe supporting eyewear system;

FIG. 10 illustrates a left, side elevation view of a loupe supporting eyewear system;

FIG. 11 illustrates an exploded view of a loupe supporting eyewear system with the temple arms not shown;

FIG. 12 illustrates a cross-section of a side elevation view of a loupe supporting eyewear system with the temple arms removed;

FIG. 13 illustrates a cross-section of a front perspective view of a loupe supporting eyewear system; and

FIG. 14 illustrates a front, right, side perspective view of a loupe supporting eyewear system with two loupe holding shelves.

### DETAILED DESCRIPTION OF EXAMPLE EMBODIMENTS

The following descriptions depict only example embodiments and are not to be considered limiting in scope. Any reference herein to “the invention” is not intended to restrict or limit the invention to exact features or steps of any one or more of the exemplary embodiments disclosed in the present specification. References to “one embodiment,” “an embodiment,” “various embodiments,” and the like, may indicate that the embodiment(s) so described may include a particular feature, structure, or characteristic, but not every embodiment necessarily includes the particular feature, structure, or characteristic. Further, repeated use of the phrase “in one embodiment,” or “in an embodiment,” do not necessarily refer to the same embodiment, although they may.

Reference to the drawings is done throughout the disclosure using various numbers. The numbers used are for the convenience of the drafter only and the absence of numbers in an apparent sequence should not be considered limiting and does not imply that additional parts of that particular embodiment exist. Numbering patterns from one embodiment to the other need not imply that each embodiment has similar parts, although it may.

Accordingly, the particular arrangements disclosed are meant to be illustrative only and not limiting as to the scope of the invention, which is to be given the full breadth of the appended claims and any and all equivalents thereof. Although specific terms are employed herein, they are used in a generic and descriptive sense only and not for purposes of limitation. Unless otherwise expressly defined herein, such terms are intended to be given their broad, ordinary, and customary meaning not inconsistent with that applicable in the relevant industry and without restriction to any specific embodiment hereinafter described. As used herein, the article “a” is intended to include one or more items. When used herein to join a list of items, the term “or” denotes at least one of the items, but does not exclude a plurality of items of the list. For exemplary methods or processes, the sequence and/or arrangement of steps described herein are illustrative and not restrictive.

It should be understood that the steps of any such processes or methods are not limited to being carried out in any particular sequence, arrangement, or with any particular graphics or interface. Indeed, the steps of the disclosed processes or methods generally may be carried out in various sequences and arrangements while still falling within the scope of the present invention.

The term “coupled” may mean that two or more elements are in direct physical contact. However, “coupled” may also mean that two or more elements are not in direct contact with each other, but yet still cooperate or interact with each other.

The terms “comprising,” “including,” “having,” and the like, as used with respect to embodiments, are synonymous, and are generally intended as “open” terms (e.g., the term “including” should be interpreted as “including, but not limited to,” the term “having” should be interpreted as “having at least,” the term “includes” should be interpreted as “includes, but is not limited to,” etc.).

As previously discussed, there is a need for a loupe supporting eyewear system that is interchangeable with each eye, and which is cross-compatible with a multiple loupes and monocles across fields of use. Likewise, there is a need for a loupe supporting eyewear system that permits a user to position the loupe in front of either the left or right eye, or both, depending on the circumstances. The loupe supporting eyewear system disclosed herein solves these and other problems.

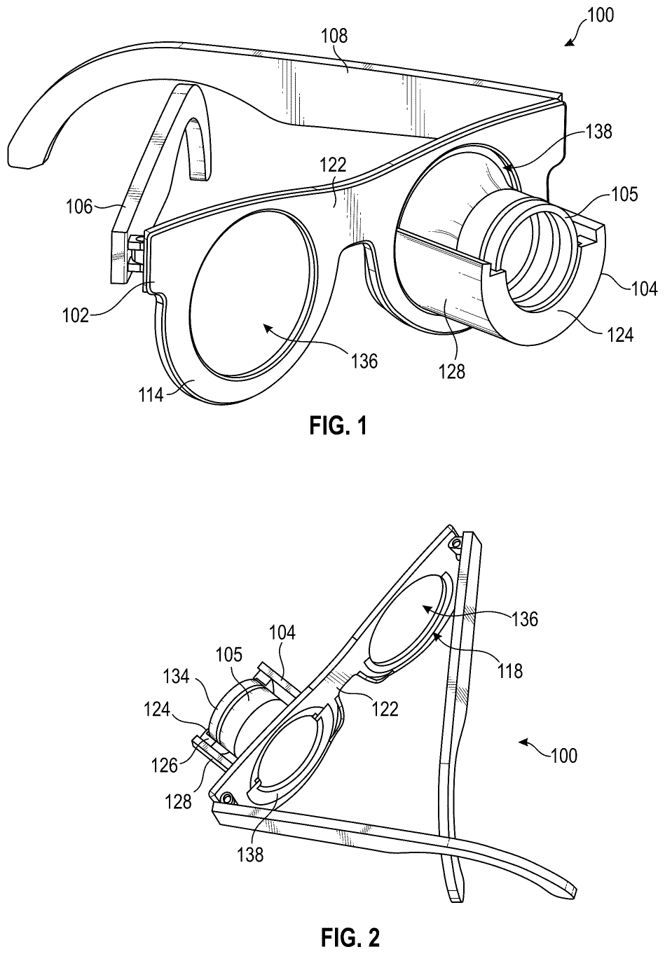

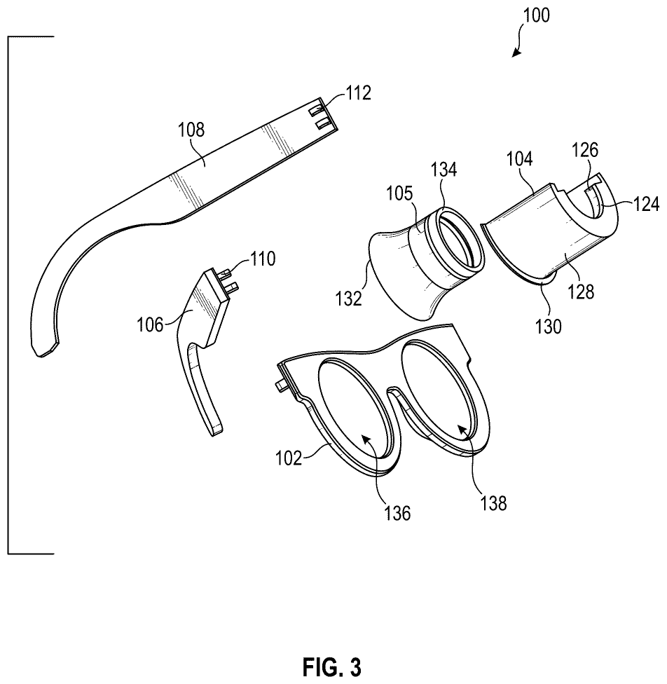

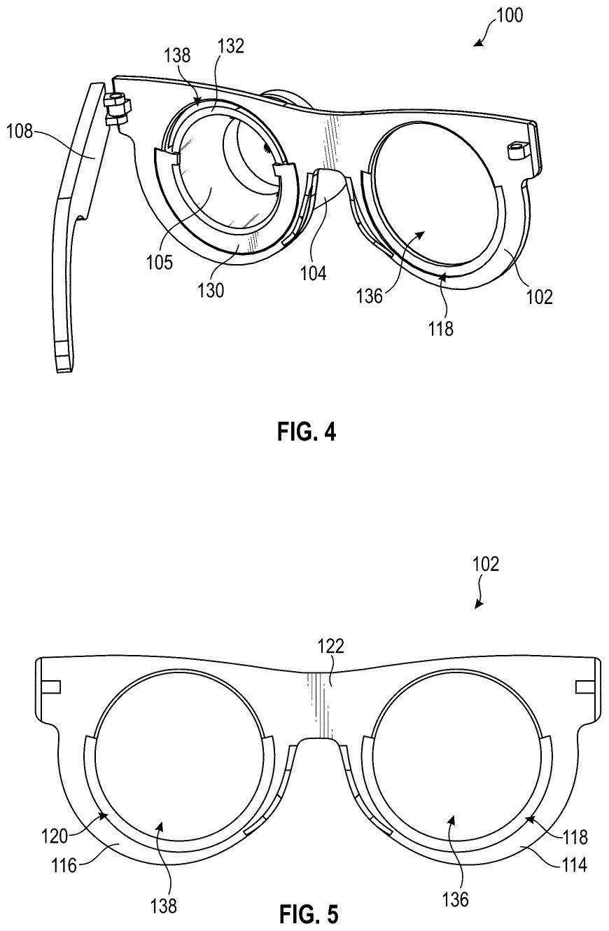

In some embodiments, as shown in FIGS. 1-5, a loupe supporting eyewear system 100 comprises eyewear frames 102 and one or more loupe holding shelves 104 removably couplable to the eyewear frames 102, the one or more loupe holding shelves 104 each configured to receive a loupe 105. As appreciated, the eyewear frames 102 may be configured as a standard pair of glasses, comprising a first temple arm 106, a second temple arm 108, a first hinge 110 coupling the first temple arm 106 to the eyewear frames 102, and a second hinge 112 coupling the second temple arm 108 to the eyewear frames 102.

As best seen in FIG. 5, to couple the one or more loupe holding shelves 104 to the eyewear frames 102, the eyewear frames 102 further comprise a first rim 114, a second rim 116, a first groove 118 on the rear side (proximal to a user's face) of the first rim 114, a second groove 120 on the rear side of the second rim 116, and a bridge 122 coupling the first rim 114 to the second rim 116.

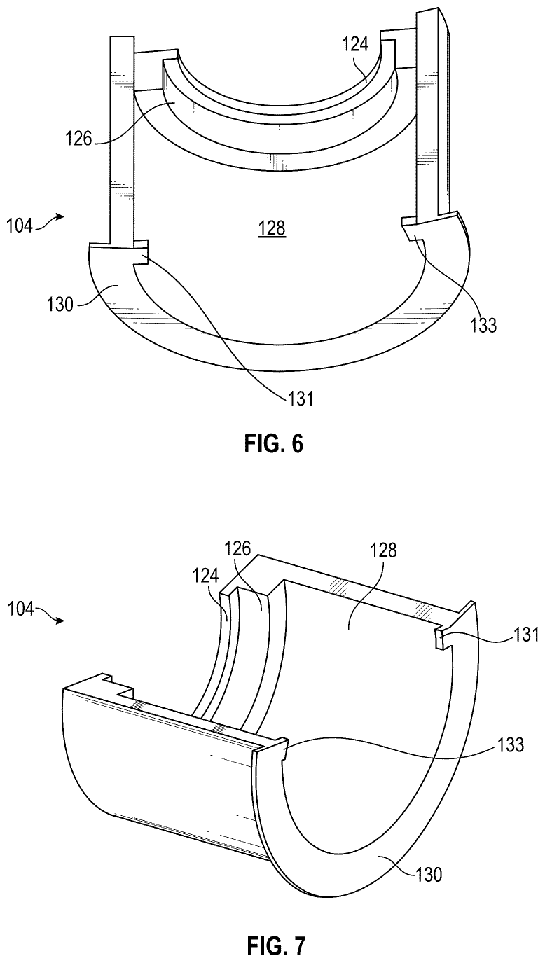

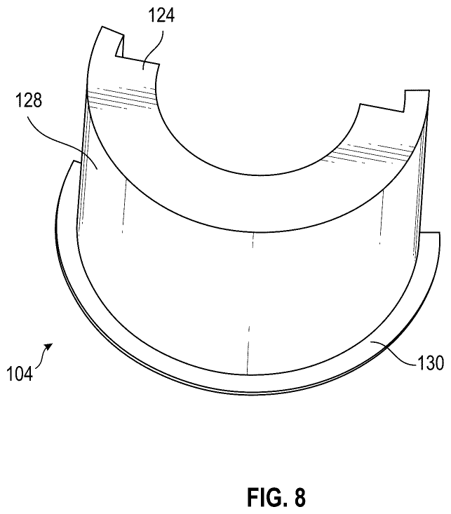

Referring to FIGS. 6-8, the one or more loupe holding shelves 104 further comprise a first semicircular ridge 124, a second semicircular ridge 126, a body 128 extending from the first semicircular ridge 124, and a lip 130 positioned at second end of the body 128 opposite the first semicircular ridge 124. It will be appreciated that while the ridges 124, 126 and lip 130 are shown and/or described as being semicircular, other shapes and configurations may be used without departing herefrom. For example, the first ridge 124 and the lip 130 may be circular, which still allows for the loupe 105 to be inserted therebetween. Other configurations may be used without departing herefrom.

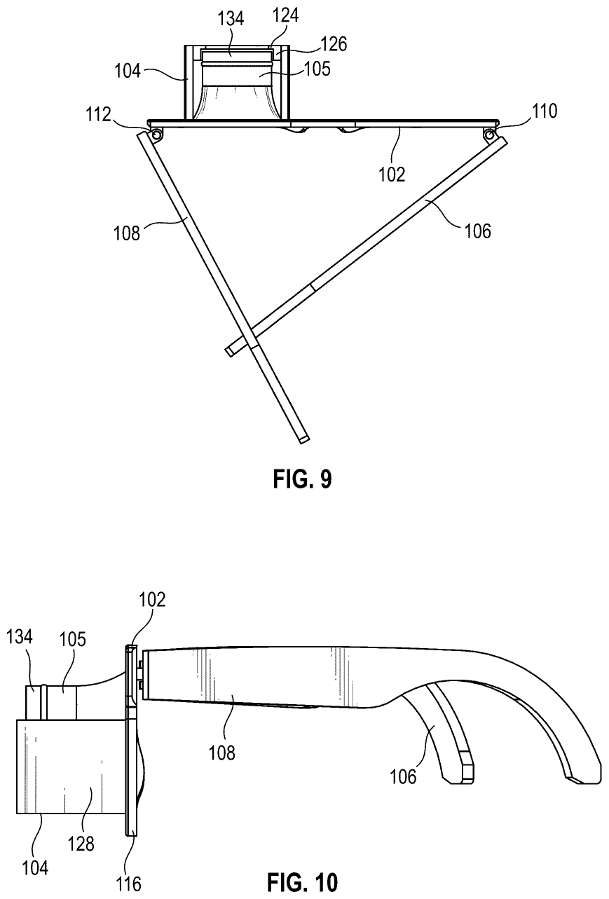

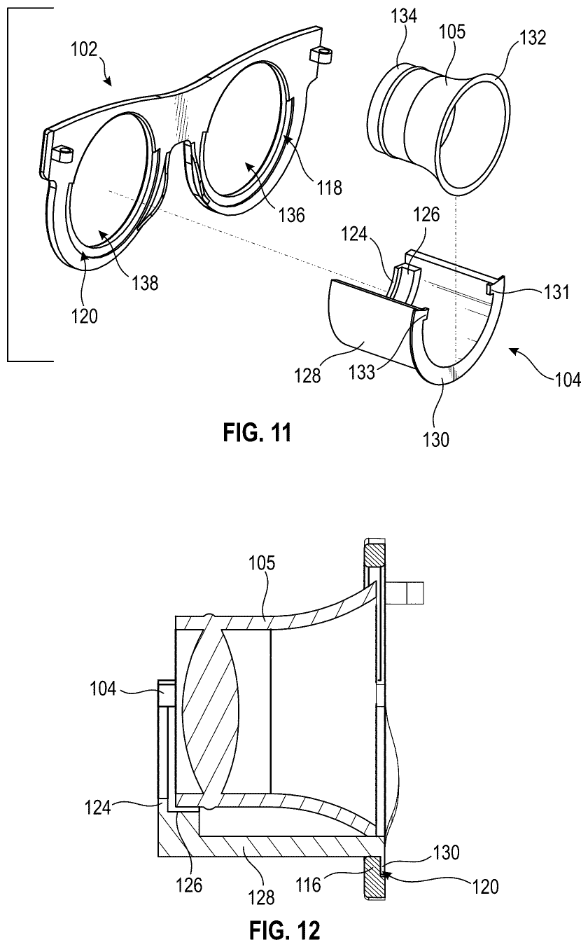

FIGS. 9-13 illustrate various views of the loupe supporting eyewear system 100. FIG. 11, illustrates how the loupe 105 is placed or pressed (e.g., interference fit) into the loupe holding shelf 104. In other words, a first end 132 (front) of the loupe 105 is positioned near the lip 130 and is configured to approximate or abut a first protrusion 131 and a second protrusion 133, both of which extend inwardly from the lip 130, with the lip 130 extending radially outwardly from the body 128. The second end 134 of the loupe 105 approximates or abuts the inner surface of the first semicircular ridge 124 to prevent the loupe 105 from sliding out of the body 128. In other words, the loupe 105 is interposed between the first and second protrusions 131, 133 and the first ridge 124.

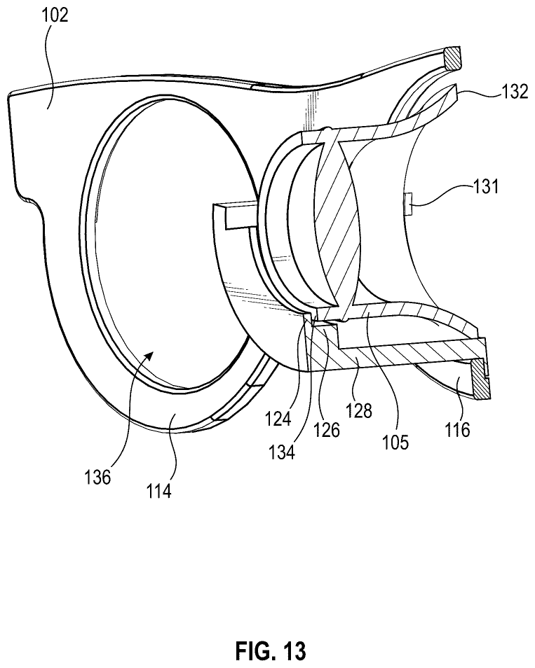

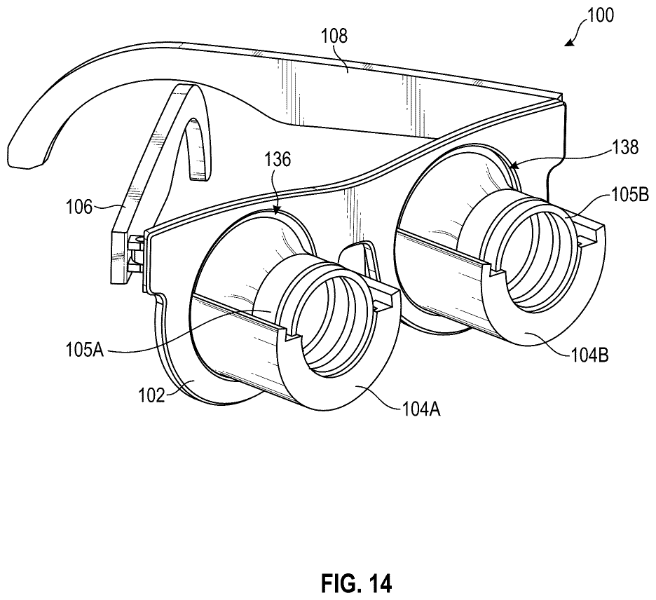

As best shown in the cross-sections of FIGS. 12-13, the second semicircular ridge 126 supports the outer surface of the second end 134 of the loupe 105 to aid in preventing or reducing movement/rattling of the loupe 105 when placed within the loupe holding shelf 104. FIG. 12 also illustrates that the lip 130 is seated in the second groove 120 of the rim 116.

Referring back to FIG. 11, a user may place the loupe 105 into the loupe holding shelf 104, and then may insert the loupe holding shelf 104 through the desired first rim aperture 136 or second rim aperture 138. Once the body 128 has passed through the selected rim aperture 136, 138, the lip 130 is received in the first groove 118 or the second groove 120, respectively. The lip 130 may “snap” into place via interference fit, or may simply rest in the selected groove 118, 120. Interference fit is preferred, so as to avoid the loupe holding shelf from inadvertently falling free of the selected groove 118, 120. Other configurations may be used, such as mating protrusions and apertures that can likewise “snap” into place, or locking mechanisms may be used, such as slide locks, pivoting arms, etc. However, if simply resting in the selected groove 118, 120, because a user is generally looking downward when the loupe supporting eyewear system 100 is being worn, the loupe holding shelf 104 remains seated within the selected groove 118, 120 due to gravitational force.

As appreciated, the first ridge 124, second ridge 126, and body 128 each have a width or span less than the diameter of the first rim aperture 136 and second rim aperture 138, respectively, so as to pass therethrough, with the lip 130 being wider than the diameter of the first rim aperture 136 and second rim aperture 138 so as to prevent the loupe holding shelf 104 from passing all the way through, and, instead, the lip 130 seating in the respective first or second groove 118, 120.

Accordingly, the user may easily remove and replace the loupe 105 for their desired magnification, and may easily switch between which eye views through the loupe 105 by simply removing the loupe holding shelf 104 (i.e., sliding it backwards through the rim aperture 136, 138) and then inserting it into the opposite rim aperture 136, 138.

Further, a user may desire to utilize a loupe 105 for each eye. For example, referring to FIG. 14, a user may have at least two loupe holding shelves 104A-B, wherein each loupe holding shelf 104A-B receives a respective loupe 105A-B, and is then received within a respective rim aperture 136, 138 to be coupled to the eyewear frame 102. As appreciated, the loupes may be easily changed by a user at any time, depending on their desired magnification, without changing the eyewear itself.

Therefore, in some embodiments, a loupe supporting eyewear system 100 has a first configuration in which the loupe holding shelf 104 is coupled to the first rim 114. A loupe supporting eyewear system 100 has a second configuration in which the loupe holding shelf 104 is coupled to the second rim 116. A loupe supporting eyewear system 100 has a third configuration in which a first loupe holding shelf 104A is coupled to the first rim 114 and a second loupe holding shelf 104B is coupled to the second rim 116.

It will be appreciated that the first configuration and the second configuration may be used depending on the dominant eye of the user, or according to the user's preference. The third configuration may be used in circumstances where the user intends to wear the loupes 105A-B with both eyes, as often occurs during prolonged periods of use when the user does not want differential fatigue between the eyes.

In some embodiments, a loupe supporting eyewear system 100 comprises lenses configured to fit in the rim apertures 136, 138. The lenses may function to protect the user from the one or more loupes 105A-B falling backwards towards the user's eyes, or may be configured to magnify and otherwise enhance the clarity of the view through the one or more loupes 105A-B. In other words, the lenses may be removably securable to the eyewear frames 102 so as to allow removal or insertion of the loupe holding shelf.

Other methods of securing the loupe holding shelf 104 to the eyewear frames may be used, such as a twist and lock arrangement (e.g., rotating the loupe holding shelf 104 in relation to the eyewear fames to secure them therein using a tongue and groove relationship), securing tabs and apertures (such as pivotable tabs extending from the loupe holding shelf 104 that are each receivable within a respective aperture on the selected rim 114, 116, wherein the tab may be rotated after passing therethrough to secure the configuration), and other configurations. Some configurations, such as the tab and aperture arrangement may allow the loupe holding shelf 104 to be secured to the front of the eyewear frames, rather than passing through a respective rim aperture 136, 138.

In some embodiments, the loupe holding shelves 104A-B may be more permanently secured to the eyewear frame 102, such as by using adhesives, screws, etc. In such a scenario, the body 128 is of sufficient length so as to allow the loupes 105A-B to be removed from the top of the loupe holding shelf 104 without hitting or being restricted by the eyewear frames 102. This allows a user to easily swap the desired loupes 105A-B for the desired magnification, without needing multiple headwear units, as is required by the prior art.

Accordingly, it will be appreciated from the foregoing that the loupe supporting eyewear system 100 disclosed herein solves the need for a loupe supporting eyewear system that is interchangeable with each eye, and which is cross-compatible with a multiple loupes and monocles across fields of use. Likewise, it solves the need for a loupe supporting eyewear system that permits a user to position the loupe in front of either the left or right eye, or both, depending on the circumstances, providing a more efficient and user-friendly experience, and overcoming the limitations of the prior art.

It will be appreciated that systems and methods according to certain embodiments of the present disclosure may include, incorporate, or otherwise comprise properties or features (e.g., components, members, elements, parts, and/or portions) described in other embodiments. Accordingly, the various features of certain embodiments can be compatible with, combined with, included in, and/or incorporated into other embodiments of the present disclosure. Thus, disclosure of certain features relative to a specific embodiment of the present disclosure should not be construed as limiting application or inclusion of said features to the specific embodiment unless so stated. Rather, it will be appreciated that other embodiments can also include said features, members, elements, parts, and/or portions without necessarily departing from the scope of the present disclosure.

Moreover, unless a feature is described as requiring another feature in combination therewith, any feature herein may be combined with any other feature of a same or different embodiment disclosed herein. Furthermore, various well-known aspects of illustrative systems, methods, apparatus, and the like are not described herein in particular detail in order to avoid obscuring aspects of the example embodiments. Such aspects are, however, also contemplated herein.

Exemplary embodiments are described above. No element, act, or instruction used in this description should be construed as important, necessary, critical, or essential unless explicitly described as such. Although only a few of the exemplary embodiments have been described in detail herein, those skilled in the art will readily appreciate that many modifications are possible in these exemplary embodiments without materially departing from the novel teachings and advantages herein. Accordingly, all such modifications are intended to be included within the scope of this invention.

What is claimed is:

1. A loupe supporting eyewear system, comprising:
an eyewear frame, comprising:
a first rim comprising a first rim aperture, and
a second rim comprising a second rim aperture;
a first temple arm coupled to a first side of the eyewear frame;
a second temple arm coupled to a second side of the eyewear frame; and
a loupe holding shelf configured to be selectively insertable into the first rim aperture or second rim aperture, and further configured to couple to the first rim or second rim, respectively, of the eyewear frame.

2. The loupe supporting eyewear system of claim 1, wherein the first rim comprises a first groove to receive a portion of the loupe holding shelf.

3. The loupe supporting eyewear system of claim 2, wherein the second rim comprises a second groove to receive the portion of the loupe holding shelf.

4. The loupe supporting eyewear system of claim 2, wherein the loupe holding shelf comprises a lip 130 configured to be received in the first groove.

5. The loupe supporting eyewear system of claim 3, wherein the loupe holding shelf comprises a lip 130 configured to be received in either the first groove or the second groove.

6. The loupe supporting eyewear system of claim 1, wherein the loupe holding shelf comprises a first ridge on a first end and a lip on a second end.

7. The loupe supporting eyewear system of claim 1, wherein the loupe holding shelf comprises a first ridge on a first end of a body, a second ridge proximal to the first ridge, and a lip on a second end of the body.

8. The loupe supporting eyewear system of claim 7, wherein the lip is configured to be received in a first groove of the first rim aperture.

9. The loupe supporting eyewear system of claim 8, wherein the lip is configured to be received in a second groove of the second rim aperture.

10. A loupe supporting eyewear system, comprising:
an eyewear frame, comprising:
a first rim comprising a first rim aperture and a first groove on a rear side, and
a second rim comprising a second rim aperture and a second groove on the rear side;
a first temple arm coupled to a first side of the eyewear frame;
a second temple arm coupled to a second side of the eyewear frame; and
a first loupe holding shelf, comprising:
a body,
a first ridge on a first end of the body, and
a lip on a second end of the body;
wherein the first loupe holding shelf is configured to be selectively insertable into the first rim aperture or second rim aperture, wherein the lip is received in the first groove or the second groove, respectively.

11. The loupe supporting eyewear system of claim 10, wherein the first loupe holding shelf further comprises a second ridge proximal to the first ridge.

12. The loupe supporting eyewear system of claim 10, further comprising a second loupe holding shelf.

13. The loupe supporting eyewear system of claim 12, wherein the second loupe holding shelf comprises:
a body,
a first ridge on a first end of the body, and
a lip on a second end of the body.

14. The loupe supporting eyewear system of claim 12, wherein the first loupe holding shelf is coupled to the first groove of the first rim and the second loupe holding shelf is coupled to the second groove of the second rim.

15. A loupe supporting eyewear system, comprising:
an eyewear frame, comprising:
a first rim comprising a first rim aperture, and
a second rim comprising a second rim aperture;
a first temple arm coupled to a first side of the eyewear frame;
a second temple arm coupled to a second side of the eyewear frame; and
a first loupe holding shelf configured to be selectively insertable into the first rim aperture; and
a second loupe holding shelf configured to be selectively insertable into the second rim aperture.

16. The loupe supporting eyewear system of claim 15, wherein the first rim comprises a first groove and the second rim comprises a second groove.

17. The loupe supporting eyewear system of claim 16, wherein the first loupe holding shelf comprises a first lip for coupling to the first groove, and the second loupe holding shelf comprises a second lip for coupling to the second groove.

18. The loupe supporting eyewear system of claim 17, wherein the first loupe supporting shelf comprises a first ridge with a body extending between the first ridge and the first lip, and the second loupe supporting shelf comprises a first ridge with a body extending between the first ridge and the second lip.

19. The loupe supporting eyewear system of claim 15, wherein the first loupe supporting shelf is semicircular and the second loupe supporting shelf is semicircular.

20. The loupe supporting eyewear system of claim 17, wherein the first lip of the first loupe supporting shelf is wider than a diameter of the first rim aperture, and the second lip of the second loupe supporting shelf is wider than a diameter of the second rim aperture.
